(19) United States
(12) Patent Application Publication
(10) Pub. No.: US 2007/0132867 A1
(43) Pub. Date: Jun. 14, 2007

(54) Multimode CMOS Image Sensor

(75) Inventors: Jehyuk Rhee, Chandler, AZ (US); Youngjoong Joo, Chandler, AZ (US)

Correspondence Address: FULBRIGHT & JAWORSKI L.L.P., 600 CONGRESS AVE., SUITE 2400, AUSTIN, TX, 78701, US

(73) Assignee: ARIZONA BOARD OF REGENTS FOR AND ON BEHALF OF ARIZONA STATE UNIVERSITY

(21) Appl. No.: 11/608,539

(22) Filed: Dec. 8, 2006

Related U.S. Application Data
(60) Provisional application No. 60/748,384, filed on Dec. 8, 2005.

(51) Int. Cl. H04N 3/14

(52) U.S. Cl. 348/302; 250/214 R; 250/208.1

(57) ABSTRACT

Methods and devices for a multi-mode CMOS image sensor are presented. In one respect, the methods can provide varying at least one of a plurality of control signals of a pixel of a CMOS image sensor, where the pixel is operable in a linear mode, logarithmic mode, and floating point mode. The pixel may include a plurality of transistors and a photodetector coupled thereto. Using a plurality of control signals, the mode of the pixel can change between a linear mode, a logarithmic mode, and a floating point mode.

This patent application claims priority to, and incorporates by reference in its entirety, U.S. Provisional Patent Application Ser. No. 60/748,384 filed on Dec. 8, 2005.

### BACKGROUND OF THE INVENTION

1. Field of the Invention

This invention relates to a Complementary Metal Oxide Semiconductor (CMOS) image sensor, and more particularly, to a CMOS image sensor capable of multimode operation.

2. Description of Related Art

Complementary Metal Oxide Semiconductor (CMOS) image sensors are the subject of significant research and development, attracting attention in the field of electronic imaging that has previously been dominated by charge-coupled devices (CCDs). This is due to some of the performance benefits of CMOS, such as the ability to handle a wider dynamic range (DR) of optical intensity than CCDs, as well as economic considerations.

In outdoor environments, the light intensity can vary over a wide range—around six decades (or about 120 dB). For these environments, image sensors with a logarithmic response, including logarithmic CMOS image sensors, are typically used. However, the nonlinear transfer characteristics of these logarithmic image sensors make signal processing difficult. Further, these types of sensors suffer from low signal to noise ratio (SNR) due to small signal swing, and their operation is sensitive to device parameter variations, such as transistor threshold voltage. These issues with conventional logarithmic CMOS image sensors cause, among other things, fixed pattern noise (FPN), a distortion in the captured image.

Another technique to obtain a wide dynamic range is floating point mode operation. Currently, most floating point sensors are based on controlling an integration time. The linear characteristic of floating point mode imagers makes signal processing easy and also provides better quality of image on both bright and dark illumination. However, integration times can limit the frame rate, and the mode typically has high power consumption, since multiple read-outs are needed to obtain and use an optimum integration time.

Any shortcoming mentioned above is not intended to be exhaustive, but rather is among many that tends to impair the effectiveness of previously known techniques for image sensors; however, shortcomings mentioned here are sufficient to demonstrate that the methodologies appearing in the art have not been completely satisfactory and that a significant need exists for the techniques described and claimed in this disclosure.

### SUMMARY OF THE INVENTION

The present disclosure provides methods and device for multimode CMOS imaging. In one respect, the method provides varying at least one of a plurality of control signals of a pixel that may be operable in linear mode, logarithmic mode, and floating point mode. By varying the signals, the method enables a CMOS image sensor to operate in one of the linear mode, logarithmic mode, and floating point modes.

In one respect, the CMOS image sensor may operate in a logarithmic mode which may include a step of calibrating the pixel with a current. Alternatively, the CMOS image sensor may operate in a floating point mode, which includes performing a sampling procedure on the pixel. In other respects, the CMOS image sensor may operate in a linear mode, which may include a reset process, integration process, and a readout process.

The present disclosure provides an image pixel that includes a plurality of transistors and a photodetector coupled to at least one of the transistors. Controls signals, which may apply certain voltages or currents to the transistors, may be configured to change a mode of operation of the image pixel between linear mode, logarithmic mode, and floating point mode.

The term “coupled” is defined as connected, although not necessarily directly, and not necessarily mechanically.

The terms “a” and “an” are defined as one or more unless this disclosure explicitly requires otherwise.

The term “substantially,” “about,” “approximation” and its variations are defined as being largely but not necessarily wholly what is specified as understood by one of ordinary skill in the art, and in one non-limiting embodiment these terms refer to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWING

The following drawings form part of the present specification and are included to further demonstrate certain aspects of the present disclosure. The figures are examples only. They do not limit the scope of the disclosure.

FIG. 1 is a schematic circuit design showing a pixel of a CMOS sensor, in accordance with embodiments of this disclosure.

FIG. 2 shows timing control signals for a linear mode operation of the pixel shown schematically in FIG. 1, in accordance with embodiments of this disclosure.

FIG. 3 shows timing control signals for a logarithmic mode of operation of the pixel shown schematically in FIG. 1, in accordance with embodiments of this disclosure.

FIG. 4 shows timing control signals for a floating point mode of operation of the pixel shown schematically in FIG. 1, in accordance with embodiments of this disclosure.

FIG. 5 shows a layout of a multimode pixel for a CMOS sensor, in accordance with embodiments of this disclosure.

FIG. 6 is a graph showing a simulated repsonse for linear mode operation of the pixel shown schematically in FIG. 1, with layout shown in FIG. 5, in accordance with embodiments of this disclosure.

FIG. 7 is a graph showing a simulated repsonse for logarithmic mode operation of the pixel shown schematically in FIG. 1, with layout shown in FIG. 5, in accordance with embodiments of this disclosure.

FIG. 8 is a graph showing a simulated repsonse for floating point mode operation of the pixel shown schematically in FIG. 1, with layout shown in FIG. 5, in accordance with embodiments of this disclosure.

FIG. 9 is a graph showing measured pixel response as a function of illumination for logarithmic mode operation of a pixel, in accordance with embodiments of this disclosure.

FIG. 10 is a graph showing measured pixel response as a function of illumination for floating pont mode operation of a pixel, in accordance with embodiments of this disclosure.

### DETAILED DESCRIPTION OF THE INVENTION

The disclosure and its various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those of ordinary skill in the art from this disclosure.

Current CMOS image sensors only allow one mode of operation, which is not necessarily the optimum mode of operation for all imaging instances. The present disclosure provides for optimizing imaging performance in CMOS image sensors by providing multiple modes of operation, where a mode may be selected manually or adaptively.

In one respect, the CMOS image sensors of the present disclosure may operate in linear, logarithmic, and floating point mode. Additionally, the present disclosure provides techniques for reducing sampling procedures, and thus, sensors can be made to consume less power as compared to current sensors in the art.

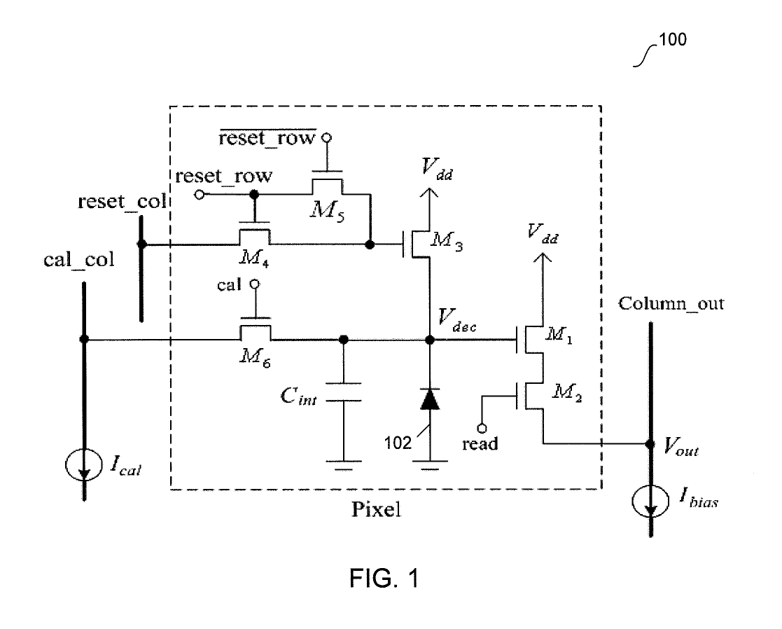

Referring to FIG. 1, a schematic of a pixel 100 in accordance with the present disclosure is shown. Pixel 100 includes six NMOS transistors (labeled M1, M2, M3, M4, M5, and M6) operable with control signals, such as, but not limited to, control row signals and control column signals. In an exemplary embodiment, pixel 100 may operate with four row signals and four column signals, although one of ordinary skill in the art can recognize that any number of control signals may be used. By control row signals, it is meant a signal that may be applied to at least one row of pixel 100. Similarly, by control column signals, it is meant a signal that may be applied at least one column of pixel 100.

In one respect, the control signals may be include “cal-col”, “reset_col”, “reset_row”, “reset_row”, “cal”, “read”, V_{dd}, and V_{dec}, as shown in FIG. 1. “cal_col” is a control signal that may calibrate a device, such as transistor M6 by, for example, an applied current. To calibrate a pixel, a current may be selected by a calibration signal (cal_sig) from a reference current source (not shown) that may be applied to a pixel. It is noted that other controls signals may also be used.

“reset_col” represents a control signal that may control a voltage applied to a transistor, for example, the drain of transistor M4, for resetting a pixel. The pixel may be reset when both reset_col and reset_row (described below) are high (e.g., a high voltage V_{dd} may be applied to the transistor). In one respect, the reset_col signal may indicate a high voltage or low voltage. For example, when reset col is set to high (or to 1), a high voltage may be applied to the transistor. Similarly, when reset_col is set to low (or to 0), a low voltage may be applied. Using a 3.3 Volt (V) CMOS process as an example, a typical low voltage is approximately 0V, although other voltages that allow the transistor to be operated in a similar manner may also be used. A typical high voltage is approximately 3.3V, although other voltages that allow the transistor to be operated in a similar manner may also be used. The voltage applied by signal reset_col may be controlled using memory (not shown) that stores information including reset timing information.

“reset_row” represents a control signal that may control a voltage applied to transistors M4 and M5 for resetting a pixel. The pixel may be reset when both reset_col and reset_row are high. In one respect, the reset_row signal may indicate a high voltage or a low voltage. For example, when reset_row is set to high (or to 1), a high voltage may be applied to the transistor. Similarly, when reset_row is set to low (or to 0), a low voltage may be applied.

In one respect, the high voltage may be approximately one transistor threshold voltage (Vₜₕ) higher than V_{dd} to make the voltage applied to the gate of transistor M3 be approximately equal to V_{dd}. This high level of voltage may be acquired by using, for example, a charge pump. Using a 3.3 V CMOS process as an example, a typical high voltage may be approximately one transistor threshold voltage above 3.3 V (i.e. approximately 4.0 V, assuming a transistor threshold voltage of 0.7 V), although other voltages that allow the transistor to be operated in a similar manner may also be used. A typical low voltage may be approximately 0V, although other voltages that allow the transistor to be operated in a similar manner may also be used.

“reset _row” represents a control signal that is a complement signal to the reset_row signal. The role of this complement signal is to make the gate of M3 become low when reset_col stays high and reset_row transits from high to low (the gate of M3 may stay high unless transistor M5 is on because that node is floating). In some respects, the reset_row signal may control whether a high voltage or low voltage is applied to a transistor. Using a 3.3 V CMOS process as an example, a typical low voltage may be approximately 0V, although other voltages that allow the transistor to be operated in a similar manner may also be used. A typical high voltage is approximately 3.3 V, although other voltages that allow the transistor to be operated in a similar manner may also be used.

“cal” represents a control signal that may apply a voltage to transistor M6 for calibrating a pixel. For example, when the cal signal is high (“1”), a high voltage may be applied and M6 is “ON.” This may create a current path from the reference current source to the pixel. In some respects, the cal signal may be set to low (“0”) and a low voltage may be applied. Using a 3.3 V CMOS process as an example, a typical low voltage may be approximately 0V, although other voltages that allow the transistor to be operated in a similar manner may also be used. A typical high voltage may be approximately 3.3 V, although other voltages that allow the transistor to be operated in a similar manner may be used.

“read” represents a control signal that may apply a voltage to transistor M2 for reading out the detector voltage. In some respects, the read signal may apply a high voltage and a low voltage. For example, when read is set to high (or to 1), a high voltage may be applied to the transistor. Similarly, when read is set to low (or to 0), a low voltage may be applied. Using a 3.3 V CMOS process as an example, a typical low voltage may be approximately 0V, although other voltages that allow the transistor to be operated in a similar manner may also be used. A typical high voltage may be approximately 3.3 V, although other voltages that allow the transistor to be operated in a similar manner may also be used.

“V_{dd}” represents a high voltage power (supply) rail. Using a 3.3V CMOS process, V_{dd} may provide about 3.3 V although other voltages that allow transistors to be operated in a similar manner may also be used.

“V_{dec}” is a voltage output of a photodetector (e.g., diode 102). The voltage output may vary depending on the incoming illumination. Referring to FIG. 1, a photodetector of pixel 100 may be diode 102 coupled between a point in the pixel circuit labeled as V_{dec} and a current return path of pixel 100, illustrated as a ground connection. In one respect, diode 102 may be an n+/p-sub type diode. Alternatively, diode 102 may be an n-well/p-sub type diode or any other structure configured to produce an electrical output in response to an input optical signal.

Pixel 100 of FIG. 1 may also include Vₒᵤₜ as the output voltage of pixel 100. When the Vₒᵤₜ is high, Vₒᵤₜ is given by

$${V}_{out} = {V}_{dec} - {V}_{th 1} - \sqrt{\frac{{I}_{bias}}{{k}_{n 1}}} \qquad Eq . 1$$

where

$${k}_{n 1} = \frac{1}{2} {μ}_{n} {C}_{ox} \frac{{L}_{1}}{{W}_{1}} ,$$

Vₜₕ₁ is threshold voltage of M1, Cₒₓ is an oxide capacitance of transistor M1, L₁ and W₁ are a length and a width of a gate of transistor M1, respectively, and μₙ is electron mobility. I_{bias} is a current source for biasing source follower M1 of the selected pixel.

Pixel 100 may also include an integration capacitor, denoted Cᵢₙₜ in FIG. 1. Cᵢₙₜ may be coupled between transistor M6 and M3 and may be a current return path of pixel 100, illustrated as a ground connection. The integration capacitor may represent the summation of the optical detector shunt capacitance, and parasitic capacitance of transistors M1, M3, and M6.

Linear Mode

In one respect, the mode of operation may be enabled by varying the control signals. For a linear mode of operation, control signals reset_row, read, reset_col, cal, and V_{dec} may be varied. For example, to reset a detector, the read signal may be set to high prior to setting reset_row signal to either high or low, depending on various parameters. To integrate an input signal, the reset_row and read signals may be set to low, which allows the detector to integrate the input signal until the reset_row is set to high. In some embodiments, reset_col and cal signals may be set indefinitely to high and low, respectively. Alternatively, the reset_col and cal signals may fluctuate between high and low as well. For each control signal and output signal trace, a high voltage for the control signal is denoted V_{high} and a low voltage is denoted V_{low}, with the high and low voltages for each control signal having previously been described above.

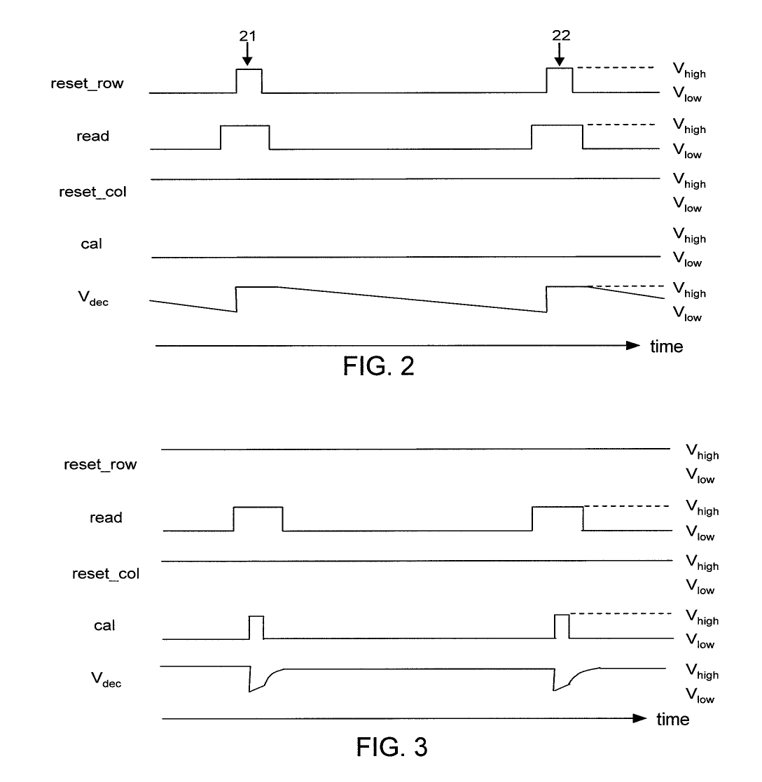

In one embodiment, the linear mode operation may have three stages: reset, integration, and readout. Referring to FIG. 2, control signals reset_row, read, and cal may be set at a low voltage (V_{low}) and reset_col may be set at a high voltage (V_{high}). When the reset_col and reset_row voltage control signals are both at a high voltage (indicated at peaks 21 and 22 in FIG. 2), transistor M3 turns on, and a reset period starts. In one respect, when the high voltage of reset_row signal is higher than V_{dd}, the gate voltage of M3 may be about V_{dd}.

When the reset_row control voltage becomes low, transistor M5 is turned ON, which turns M3 OFF, and the integration period starts. The photodiode may discharge proportional to the light intensity for integration time tᵢₙₜ. At the end of the integration period, the detector voltage V_{dec} may be read out through the source follower of transistor M1 and the row select switch M2, which may be controlled by a voltage control signal, denoted read. Also the reset voltage of the next frame may be read out for correlated double sampling (CDS). In contrast with the conventional CMOS active pixel sensor (APS), each individual pixel may have different integration time through the use of the conditional reset transistors M4 and M5.

Logarithmic Mode

As noted above, the logarithmic mode is suitable for wide dynamic range (DR) applications. Control signals operating pixel 100 in logarithmic mode may be varied. For example, to calibrate a detector, the read signal may be set to high, followed by setting the cal signal to high. To integrate an input signal, the cal signal may be set to low, as well as the read signal may be set to low. In one respect, reset_low and reset_col signals may be set to high, although the signals may also vary or may be set to low. One embodiment of the varying control signals is shown in FIG. 3.

For each control signal and output signal trace, a high voltage for the control signal is denoted V_{high} and a low voltage is denoted V_{low}, with the high and low voltages for each control signal having previously been described above. Control signal reset_row may always be held at a high voltage, resulting in transistor M3 being always on. Therefore, V_{dec} may be approximately equal to V_{dd}. Transistor M3 may work in the weak inversion region and the drain current of M3 may be equal to the photocurrent generated by the photodetector 102. The voltage of the column_out may be approximately

$${V}_{out\_s} \approx {V}_{dd} - {V}_{th , M 3} - \frac{nkT}{q} ln ( \frac{{I}_{ph}}{{I}_{0}} ) - \sqrt{\frac{2 {I}_{bias}}{{β}_{1}}} - {V}_{th , M 1} , \qquad Eq . 2$$

where k is Boltzmanns's constant, q is the electronic charge, T is temperature (in Kelvin), V_{th,M1} and V_{th,M3} are threshold voltages of transistors M1 and M3, respectively, n is the sub-threshold slope factor of transistor M3, I₀ is the drain current of transistor M3 at the onset of weak inversion, I_{bias} is a current source for biasing source follower transistor M1 of the selected pixel and β₁ is the transconductance parameter of transistor M1. Eq. 2 shows that the output voltage V_{out—s} may be logarithmically related to the photocurrent Iₚₕ generated by an incident optical signal on the pixel.

A problem with current logarithmic image sensors is the variation of transistor threshold voltages, which can cause severe FPN. To overcome this problem, a calibration technique is used. In one respect, each pixel may be calibrated against a known reference current I_{cal}. For example, after Vₒᵤₜ is sampled, control voltage cal may be pulsed high such that an additional current I_{cal} flows through transistor M6. If I_{cal} is much higher than photocurrent Iₚₕ, transistor M3 operates in strong inversion and the column_out voltage is given by

$${V}_{out\_c} \approx {V}_{dd} - {V}_{th , M 3} - \sqrt{\frac{2 {I}_{cal}}{{β}_{3}}} - \sqrt{\frac{2 {I}_{bias}}{{β}_{1}}} - {V}_{th , M 1} , \qquad Eq . 3$$

where β₃ is the conductance parameter of transistor M3. V_{out—c} may be subtracted from V_{out—s} and the result is given by

$${V}_{out\_s} - {V}_{out\_c} \approx \frac{nkT}{q} ln ( \frac{{I}_{ph}}{{I}_{0}} ) - \sqrt{\frac{2 {I}_{cal}}{{β}_{3}}} . \qquad Eq . 4$$

It should be noted that in Eq. 4, there is no term for transistor threshold voltage, the most significant source of the FPN.

Floating Point Mode

Although logarithmic mode has the widest dynamic range (DR), it may not provide the best image quality. When both wide dynamic range and high quality image are needed, the floating point mode may be utilized. Currently, several floating point image sensors have 5 been proposed using multiple integration times. These sensors have a set of integration times, which decrease exponentially over time, for example

$$\frac{{T}_{int}}{{2}^{k}} ,$$

k=0,1, . . . 2^{m}−1 (where m is an integer value greater than or equal to 4). These sensors also allow for the selection of optimum integration time, typically the longest non-saturated integration time that allows a non-saturated value for detector voltage V_{dec}, in the set of integration times.

Assuming photocurrent Iₚₕ is a constant during the longest integration time Tᵢₙₜ and photo generated charge Qₚₕ is smaller than a well capacity of the pixel Qₘₐₓ, the actual pixel value may be represented as

$${I}_{ph} \approx \frac{{Q}_{ph}}{{T}_{int} / {2}^{k}} , k - 1 , 1 , … {2}^{m} - 1. \qquad Eq . 5$$

Since Qₚₕ=Cᵢₙₜ·V_{dec}, the photocurrent may be denoted as
Iₚₕ=A·V_{dec}2^{k} Eq. 6,
where V_{dec} is the photodetector output voltage signal and A is a parameter defined as Cᵢₙₜ/Tᵢₙₜ. Therefore, DR may be expanded by 2²^{ⁿ}^{_{−1}} times. In other words, the expansion of DR may be represented by the ratio of the longest integration time to the shortest integration time. The longest integration time is limited by a system level factor such as frame rate. The shortest integration time, on the other hand, is typically implementation-dependent and therefore difficult to bind in a generalized case.

However, current floating point image sensors sample the pixel multiple times to decide an optimum integration time. This multiple sampling procedure consumes considerable power. The present disclosure provides fewer sampling procedures, namely two. The first sampling procedure may be for determining the exponent k. In one respect, the exponent k can be obtained through logarithmic mode operation. The second sampling may be for determining the mantissa Vₚₕ. The fewer number of samplings reduces power consumption.

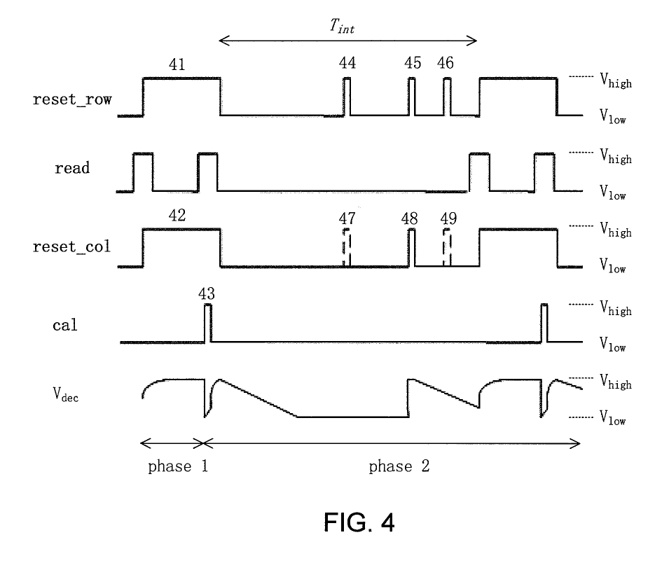

Control signals may be varied for the floating mode operation. In one respect, to read out the calibration information, reset_row and reset_col signals may be set to high. During this period, read signal may be set to high to read calibration information. For the calibration step, the cal signal may be set to high during a second high period for the read signal. An example of the varying control signals is shown in FIG. 4.

For each control signal and output signal trace, a high voltage for the control signal is denoted V_{high} and a low voltage is denoted V_{low}, with the high and low voltages for each control signal having previously been described above. The floating mode operation may include two phases. In phase 1, the reset_row and reset_col signals may both be high at the beginning of the operation (peaks labeled 41 and 42, respectively), which allows the pixel to operate in the logarithmic mode.

At the end of phase 1, the pixel output may be calibrated (the cal signal is pulsed high at peak 43) and converted to m bits of digital data. The digital data representing the exponent of the floating point are stored in memory coupled to the pixel (e.g., pixel 100). In one respect, the memory can be located either on chip or off chip. The memory device may include, but is not limited to, a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc.

In phase 2, the reset_row signal may transition to low at the beginning of the operation. Transistor M3 turns off as a result, and thus, the pixel may work in the linear integration mode. During the linear integration mode, a conditional reset may occur depending on the exponent stored in memory. A conditional reset occurs when reset_row and reset_col are both pulsed high. For example, referring to FIG. 4, a reset occurs when rest_col is pulsed high at peak 48 corresponding to peak 45 of reset_row. FIG. 4 also shows other reset points, illustrated by peaks 44, 45, and 46 for the reset_row signal, and by corresponding peaks 47, 48 and 49 for the reset_col signal. These reset points are shown by way of example only, and it will be understood that other numbers of reset points may also be used. At the end of phase 2, the pixel output voltage may be read out and the mantissa is obtained.

One of ordinary skill in the art would recognize that multiple pixels (e.g., pixel 100 of FIG. 1) may be arranged to form a CMOS image sensor. The CMOS image sensor may be used in many applications including, without limitation, industrial, consumer, medical and automotive industries.

The following examples are included to demonstrate specific embodiments of this disclosure. It should be appreciated by those of ordinary skill in the art that the techniques disclosed in the examples that follow represent techniques discovered by the inventors to function well in the practice of the invention, and thus can be considered to constitute specific modes for its practice. However, those of ordinary skill in the art should, in light of the present disclosure, appreciate that many changes can be made in the specific embodiments which are disclosed and still obtain a like or similar result without departing from the spirit and scope of the invention.

Pixel Fabricated From 0.18 μm CMOS Technology

A pixel in accordance with the present disclosure, and in particular, the pixel shown in FIG. 1, has been designed using a 0.18 μm 1-poly 6-metal 1.8V/3.3V CMOS technology, where a 3.3 V supply voltages are applied for pixel circuitry. It is noted that other CMOS processes with different geometries and different operating voltages can also be used (e.g. 0.5 μm CMOS technology and a 5V supply voltage). Thick oxide is used for all pixel circuitry to reduce gate leakage current and increase voltage swing. The gate length of transistors M1 and M3 is chosen to be longer than the minimum size allowed by a given CMOS design process to reduce threshold variation of transistors that can lead to large FPN. In one respect, the gate length for transistors M1 and M3 may be about 3 times the length of a minimum gate length, although one of ordinary skill in the art can recognize that the length of the gate may vary depending on device and design parameters, among other considerations.

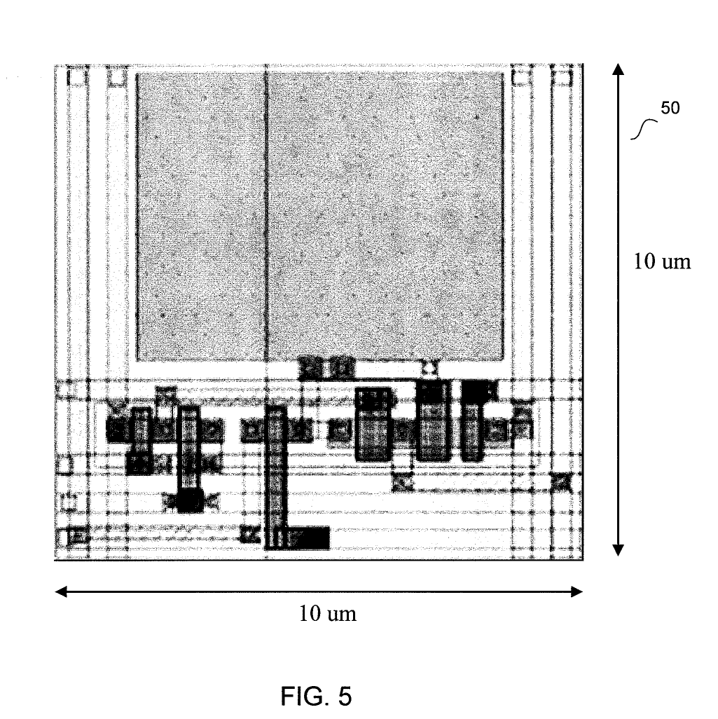

Referring to FIG. 5, a schematic layout of a multimode pixel 50 in accordance with the present disclosure is shown. The pixel is laid out to fit into 10 μm by 10 μm space, and has a fill factor of 42% (i.e. a photodetector is 42% of the area of a pixel). An n+/p-sub type diode in parallel with an ideal current source is used to model a photodiode for SPICE simulations.

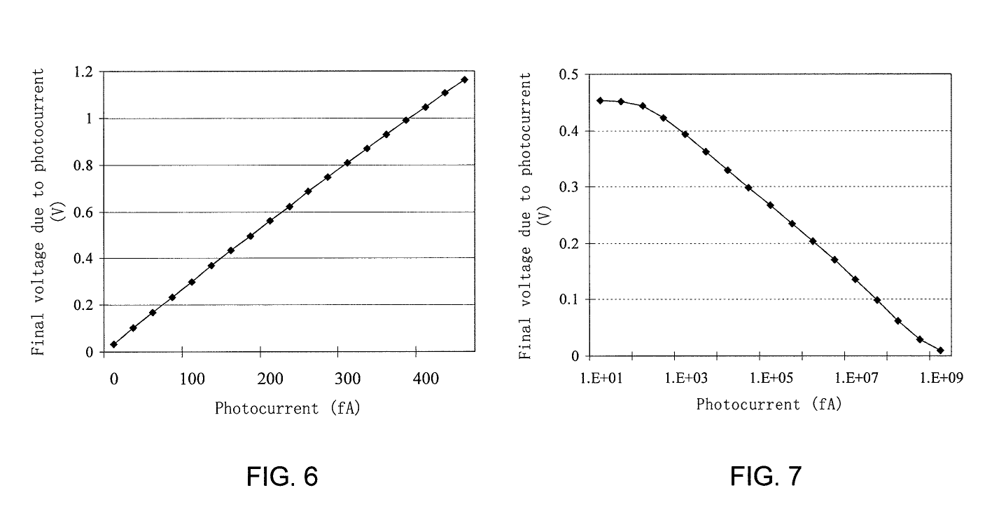

FIG. 6 shows a simulated response for linear mode operation as a function of the photocurrent for the pixel shown schematically in FIG. 5 with 10 Hz frame speed. The maximum photocurrent for the linear mode is approximately 450 fA at 100 ms integration time, which is limited by the lower bound of the readout circuits. Therefore the pixel voltage range is about 1.1 5V.

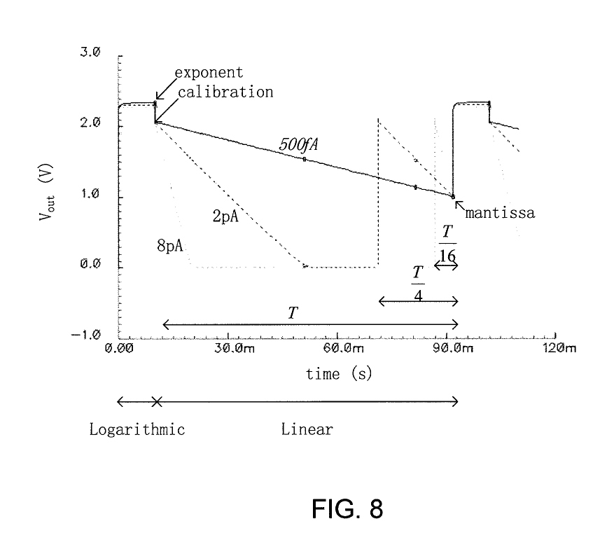

The simulated logarithmic mode response with 100 Hz frame speed is shown in FIG. 8. The calibration procedure previously described is also considered for the simulation, with a I_{cal} value of about 20 μA. As shown in FIG. 7, pixel 50 achieves more than 6 decades of DR with a response of 64 mV per frequency decade. The decreasing slope at low photocurrent region mainly results from the time requirement to charge the integration capacitance after calibration.

Referring to FIG. 8, the operation of the floating point mode for the pixel shown schematically in FIG. 5 with three different photocurrents (500 fA, 2 pA, 8 pA) is shown. Here 500 fA is the largest non-saturated photocurrent of the linear mode. All three graphs have the same mantissa value but different exponent values. For larger photocurrents, the voltage signal decreases faster. Thus as photocurrent increases, the conditional reset point is timed to occur later so that the signal does not saturate and a value for the mantissa can be obtained.

It is noted that even though the largest photocurrent shown in the FIG. 8 is about 8 pA, the pixel can handle much larger current. The largest signal is decided by the shortest integration time. For example, the sensor uses a rolling shutter scheme and per column A/D converter architecture such that the shortest integration time is the same as a column readout time, because all column pixels share the same reset_col line in FIG. 1. Assuming an array size of 640×480 pixels with 1.45 μs pixel readout time (including sampling, CDS, A/D conversion) the shortest integration time is about 700 μs. Since the integration time used for the simulation is about 89.6 ms, the DR expansion is about 42 dB, the largest photocurrent can be about 64 pA.

Pixel Fabricated From 0.5 μm CMOS Technology

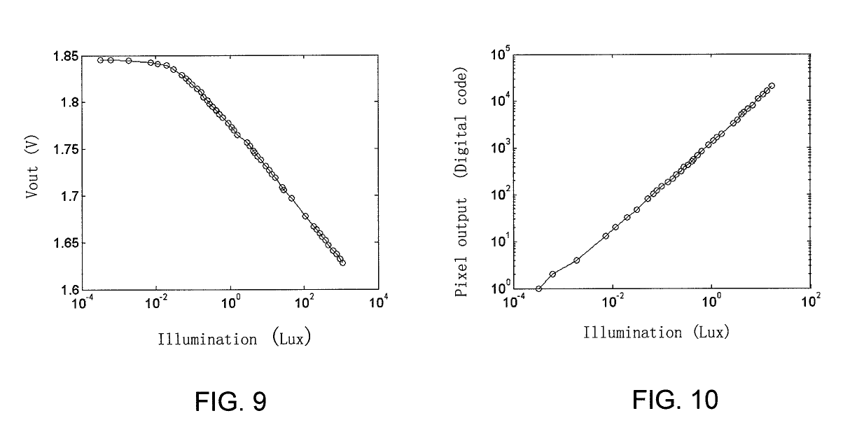

In another embodiment of the present disclosure, a pixel has been designed and fabricated using standard 0.5 μm CMOS technology and 5V supply voltages (V_{dd} ) are applied for pixel circuitry. The measured logarithmic mode pixel response with 100 Hz frame speed is shown in FIG. 9. The decreasing slope at the low light region may result from the integration capacitor charging time after calibration. The pixel was tested up to illumination levels of approximately 1100 Lux using a white light source. No saturation of the pixel response was observed. The characteristic results for this pixel show that detectable illumination can increase until M3 reaches the strong inversion region (corresponding to an intensity of >10,000 Lux).

FIG. 10 shows a floating point mode pixel response with 10.88 Hz frame speed. The phase 1 time is about 10 ms, and the phase 2 time is about 81.82 ms. The outputs are represented by 11 bits digital code (mantissa: 8 bits, exponent: 3 bits), which is about 42 dB of dynamic range expansion. The characteristics of the pixel are summarized in Table 1.

TABLE 1
Characteristic of a 0.5 μm Pixel

| Parameter | Logarithmic mode | Floating point mode |
|---|---|---|
| Technology | 0.5 μm double-poly triple-metal CMOS process | |
| Pixel size | 20.7 μm × 20.7 μm | |
| Fill factor | 34% | |
| Photodetector type | n-well/p-sub photodiode | |
| Operating voltage | 5 V | |
| Pixel responsivity | 48 mV/decade | 62 V/Lux/sec |
| Illumination range | 0.02˜over 1100 Lux | 0.0003˜25.6 Lux |
| | at 100 Hz | at 10.88 Hz |

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of ordinary skill in the art upon studying the above description.

The scope of the present disclosure includes any other applications in which embodiments of the above structures and fabrication methods are used. For example, the methods and devices of the present disclosure may be used for medical imaging. Alternatively, the methods and structures of the present disclosure may be integrated into personal or commercial imaging structures, including point-and-shoot cameras, video cameras, or other imaging products available in the art.

In some embodiments, the methods and device may be integrated for image sensors in automobiles, planes, watercrafts, or other land, air, or water vehicles that may benefit from a wide dynamic range image sensor that may be sensitive to various light intensities.

With the benefit of the present disclosure, those having skill in the art will comprehend that techniques claimed herein may be modified and applied to a number of additional, different applications, achieving the same or a similar result. The claims cover all such modifications that fall within the scope and spirit of this disclosure.

### REFERENCES

Each of the following references is hereby incorporated by reference in its entirety:
U.S. Pat. No. 6,670,656
Acosta-Serafini et al., IEEE J. Solid-State Circuits, 39:1487-1495, 2004
Acosta-Serafini et al., IEEE Trans. Intell. Transport. Sys., 5:33-41, 2004.
Baker et al., In: CMOS circuit design, layout, and simulation, Jon Wiley & Sons, Chap. 18, 1997.
Kavadis et al., IEEE J. Solid-State Circuits, 32:1146-1152, 1997.
Pylarinos and Rogers In: Charge Pumps; An Overview, Department of Electrical and Computer Engineering, University of Tornoto.
Scheffer et al., IEEE Trans. Electron, 44:1716-1720, 1997.
Tian et al., Proc. Spie, 4306:441-449, 2001.
Yadid-pecht et al., IEEE J. Solid-State Circuits, 32:285-288, 1997.
Yadid-Pecht et al., IEEE J. Solid-State Circuits, 38:1425-1428, 2003.
Yadid-Pecht, Opt. Eng., 38:650-1660, 1999.
Yang et al., IEEE J. Solid-State Circuits, 34:1821-1834, 1997.
Yasuda et al., et al., IEEE Trans. Electron, 50:111-120, 2003.

1. A method comprising:
(a) varying at least one of a plurality of control signals of a pixel of a CMOS image sensor, the pixel operable in a linear mode, logarithmic mode, and floating point mode; and
(b) enabling operation of one of the linear, logarithmic, and floating point modes by the varying step.

2. The method of claim 1, where enabling a mode of operation comprises enabling a logarithmic mode.

3. The method of claim 2, further comprising calibrating the pixel with a reference current.

4. The method of claim 1, where enabling a mode of operation comprises enabling a floating point mode.

5. The method of claim 4, further comprises performing a sampling procedure on the pixel.

6. The method of claim 5, where the sampling procedure comprises determining an exponent k for an integration time and determining a mantissa value.

7. The method of claim 4, where varying at least one of the plurality of control signals comprises varying the at least one of the plurality of control signals over two phases.

8. The method of claim 7, where after varying the plurality of control signals over a first phase, calibrating an output of the pixel.

9. The method of claim 2, where enabling a mode of operation comprises enabling a linear mode.

10. The method of claim 9, where the linear mode comprises a reset process, an integration process, and a readout process.

11. An image pixel comprising:
a plurality of transistors;
a photodetector coupled to at least one of the plurality of transistors; and
wherein the plurality of transistors are configured to operate using a plurality of control signals that change a mode of operation of the pixel between a linear mode, a logarithmic mode, and a floating point mode.

12. The image pixel of claim 11, the photodetector comprising a photodiode.

13. The image pixel of claim 11, the plurality of transistors comprising a plurality of NMOS transistors.

14. The image pixel of claim 11, the plurality of control signals comprising a current path calibration signal, at least one reset signal, a pixel calibration signal, and a voltage read signal.

15. The image pixel of claim 11, the at least one reset signal comprising a column reset signal, a row reset signal, or a complementary row reset signal.
